(19) United States
(12) Patent Application Publication
(10) Pub. No.: US 2011/0040730 A1
(43) Pub. Date: Feb. 17, 2011

(54) SYSTEM AND METHOD FOR BACKING UP AND RESTORING EMAIL DATA

(76) Inventor: Eugen Adrian Belea, Bucharest (RO)

Correspondence Address: PERKINS COIE LLP;PATENT-SEA, P.O. BOX 1247, SEATTLE, WA, 98111-1247, US

(21) Appl. No.: 12/739,719

(22) PCT Filed: Oct. 23, 2007
(86) PCT No.: PCT/IB2007/003175

§ 371 Date: Nov. 1, 2010

(51) Int. Cl. G06F 17/30; G06F 15/16

(52) U.S. Cl. 707/654; 707/E17.005; 707/E17.032

(57) ABSTRACT

A software and/or hardware facility for backing up and restoring email data. In some embodiments, the facility includes an input component configured to receive emails, a storage component configured to store the received emails non-hierarchically and an ftp component. The ftp component is configured to accept a connection from an ftp client and provide a hierarchical structure to the ftp client that enables access to the stored emails on an individual email basis.

### TECHNICAL FIELD

The present invention is directed generally toward electronic messaging systems.

### BACKGROUND

Many organizations employ electronic messaging systems to provide email services for their users. Such systems typically store the data associated with user emails as well as configuration data and other data.

System administrators typically back up data stored by electronic messaging systems. For reliability, back-up data is usually stored on a separate system. In the event of data loss the back-up data can be restored from the separate system to the electronic messaging system. Similarly, in the event of system failure the back-up data can be used to create a new electronic messaging system.

### BRIEF DESCRIPTION OF THE DRAWINGS

FIG. 1 is a block diagram that illustrates components of a facility for backing up and restoring email data.

FIGS. 2A and 2B are a block diagram of a hierarchical data structure implemented by the facility.

FIG. 3 is a flow diagram of a process for backing up email data stored by the facility.

FIG. 4 is a flow diagram of a process for restoring data to the facility.

FIG. 5 is a representative screenshot depicting an interface of an FTP client that is accessing the facility.

FIG. 6 is another representative screen shot depicting the FTP client interface.

### DETAILED DESCRIPTION

A software and/or hardware facility for backing up and restoring email data is disclosed. In some embodiments, the facility includes an input component configured to receive emails, a storage component configured to store the received emails non-hierarchically, and an ftp component. The ftp component is configured to accept a connection from an ftp client and provide to the ftp client a hierarchical structure that enables access to the stored emails on an individual email basis.

Methods for backing up and restoring email data stored by an email system are also disclosed. In some embodiments, a method of backing up email data includes opening an ftp connection to the email system having stored email data (including a plurality of emails stored non-hierarchically) and receiving an indication from the email system of a hierarchical structure that has at least one object that represents a stored email. The method further includes receiving a selection of a portion of the hierarchical structure, the selected portion having one or more objects, receiving the data corresponding to the one or more objects in the selected portion, and storing the received data as a back-up to the stored email data of the email system. In some embodiments, a method of restoring email data includes opening an ftp connection from a client that has a plurality of back-up files to an email system that stores email data that includes a plurality of emails stored non-hierarchically. The method further includes receiving an indication from the email system of a hierarchical structure. The hierarchical structure has a plurality of objects that map on a one-to-one basis to the plurality of stored emails. The method further includes providing the at least one back-up file to the email system.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### 1. Overview of the Facility

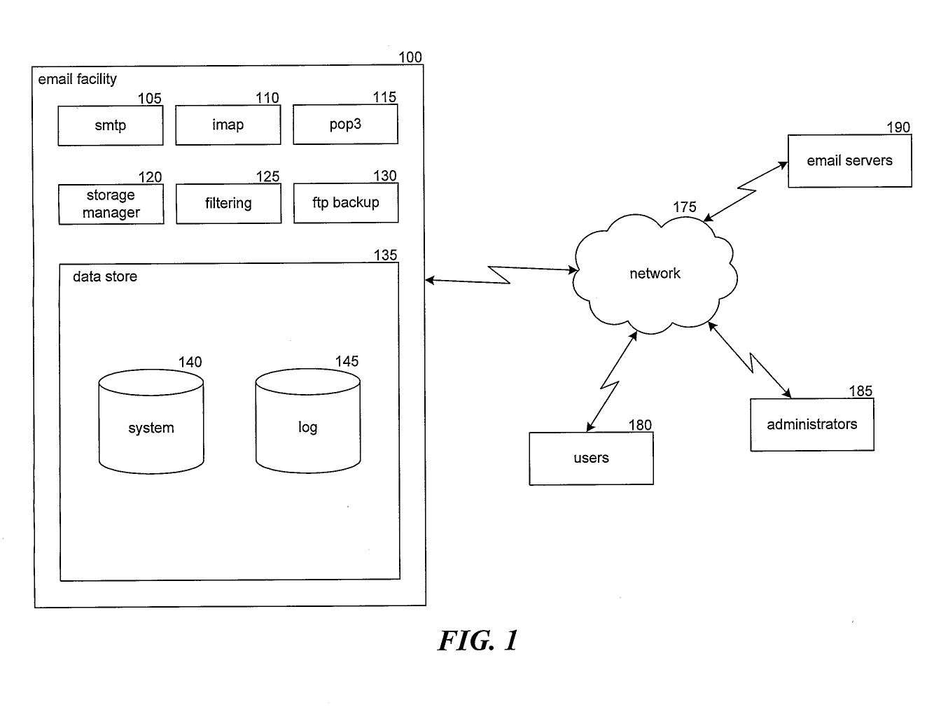

FIG. 1 is a block diagram illustrating components of an electronic mail/electronic message (“email”) software and/or hardware facility 100 (“the facility”). The facility 100 includes various components to implement the functions described herein, including a Simple Mail Transfer Protocol (SMTP) component 105, an Internet Message Access Protocol (IMAP) component 110, a Post Office Protocol 3 (POP3) component 115, a transactional storage component 120, a filtering component 125, a File Transfer Protocol (FTP) backup component 130 and a data store 135. The SMTP component 105 sends and receives emails. The IMAP 110 and POP3 115 components provide access to emails stored by the facility to users. The data store 135 can include data storage units, such as system data storage unit 140, which stores system, email and other data related to the functioning of the facility, and log data storage unit 145, which stores log data that logs aspects of the functioning of the facility. Although depicted as individual data storage units in FIG. 1, the system data storage unit 140 and the log data storage unit 145 can each be comprised of multiple data storage units. The data store 135 can also include other data stores and/or data storage units (not shown), such as an authentication/authorization data storage unit that contains access control lists with permissions or other authentication/authorization information.

The storage manager component 120 manages interactions with the data storage units, such as the system data storage unit 140. Aspects of the storage manager component are described in further detail in the co-pending patent application entitled SYSTEM AND METHOD FOR TRANSACTIONAL STORAGE OF EMAIL DATA (Attorney Docket No. 66253.8002US00), filed concurrently herewith and incorporated herein in its entirety by reference. The filtering component 125 filters and/or otherwise processes emails in accordance with rules and/or policies defined by administrators of the facility. Aspects of the filtering component 125 are described in further detail in the co-pending patent application entitled SYSTEM AND METHOD FOR FILTERING EMAIL DATA (Attorney Docket No. 66253.8001US00), filed concurrently herewith and incorporated herein in its entirety by reference. The FTP backup component 130 allows connections from FTP clients that enable them to access the data stored in the system data storage unit 140 for purposes of backing up such data and restoring the backed-up data. The FTP backup component 130 can be implemented as an FTP server that listens for incoming connections from FTP clients. The FTP backup component 130 can run as an “always-on” service that starts at system start-up or as an application program. The facility can also include other components (not shown), such as a component that provides a web or internet interface to users for purposes of accessing their emails, a component that provides a web or internet interface to administrators for purposes of administering the facility, and a component that enables administration of the facility with a command-line interface.

Users, such as users 180, can interact with the facility over a network 175, such as the Internet, for purposes of sending and receiving emails. The network 175 can also include an intranet or other private or non-public network. For example, administrators of the facility, such as administrators 185, may access the facility over a private, firewalled network that is only connected to a public network (e.g., the Internet) via a gateway device. The facility can also interact with external servers, such as email servers 190, over the network 175. Other entities (not shown) that may interact with the facility over, through or via the network 175 include routers, firewalls, application servers, database servers and other servers.

### 2. Hierarchical Data Structure

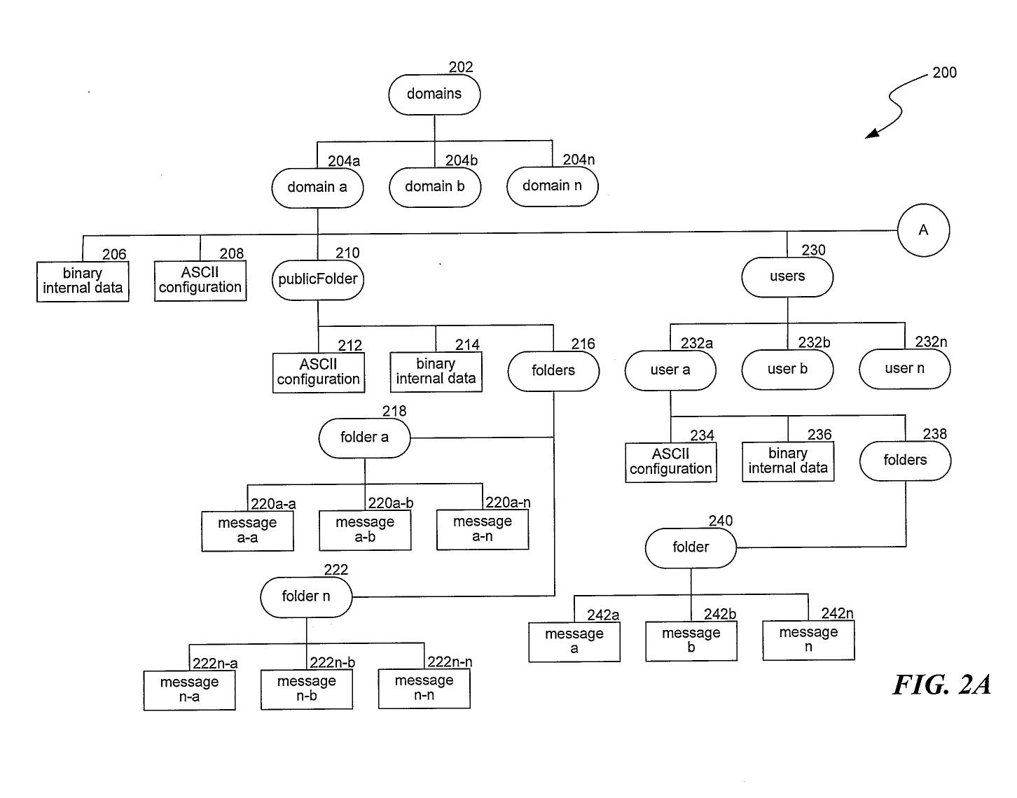

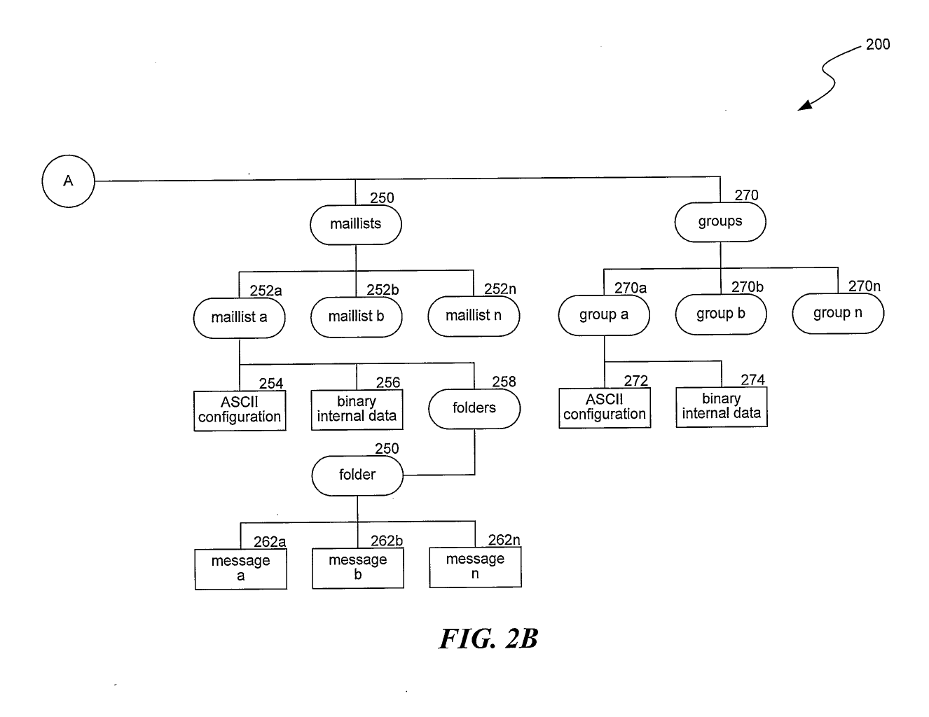

As previously described with reference to FIG. 1, the system data storage unit 140 can be comprised of one or more data storage units (hereinafter “data storage units” in the plural), in which the facility can store system, email and other data. The data stored in the data storage units can include four categories of data: 1) configuration data viewed and set by administrators that affect the functioning of the facility; 2) user settings and/or configuration data viewed and set by users that affect their interactions with the facility; 3) user email data (e.g., emails, email attachments, email metadata, and/or email-related data); and 4) internal usage data created and modified by the facility to affect its functioning. The data stored in the data storage units can also include other categories of data. The term “email data” is used to refer generally to data in the above four categories. The term “data” is used to refer generally to any data stored by the facility. The facility can store data in the data storage units in a hierarchical manner or in a non-hierarchical manner (e.g., linearly, or non-linearly, interspersed throughout multiple data storage units). If the data is stored non-hierarchically, the facility can use a Data Object Model (DOM) to hierarchically organize the data for presentment in a hierarchical structure to an FTP client. FIGS. 2A and 2B are a block diagram of a hierarchical structure 200 implemented by the facility to organize the data. The hierarchical structure 200 has a root node 202 labeled “domains.” The facility can provide email services for multiple domains, some of which may be related to each other or which each may be unrelated discrete logical entities. The root node 202 represents a collection of these domains. The root node 202 has three child nodes 204 (shown individually as nodes 204a-n). Each node 204 can represent a domain for which the facility provides email services. The node 204a (labeled “domain a”) has six child nodes. The first two nodes, nodes 206 (labeled “binary internal data”) and 208 (labeled “ASCII configuration”) represent internal usage data and configuration data, respectively. Because nodes 206 and 208 do not have any child nodes, they are called “leaf nodes.” The other four nodes, node 210 (labeled “public folder”), node 230 (labeled “users”), node 250 (labeled “maillists”) and node 270 (labeled “groups”) each represent different aspects of the email services that the facility provides for “domain a.” Although not shown in the hierarchical structure 200 for the other domains represented by nodes 204b and 204n, these aspects are equally applicable to the other domains. Node 230 represents a collection of users or accounts within “domain a.” These users include “user a,” represented by node 232a, “user b,” represented by node 232b, and “user n,” represented by node 232n. Each node 232 representing a user has child nodes that represent different aspects of the email services provided for the user. For example, node 232a (labeled “user a”) has child nodes 234 (labeled “ASCII configuration”) and 236 (labeled “binary internal data”) that represent user settings data and internal usage data, respectively. Node 232a also has child node 238 (labeled “folders”) that represents a collection of folders associated with “user a.” Node 238 has child node 240 (labeled “folder”) that represents an individual folder associated with “user a.” Node 240 has three child nodes, 242a, 242b and 242n, that each represent different messages contained within the folder represented by node 240. Node 238 can have additional child nodes (not shown) representing additional folders associated with “user a.” The other child nodes 210, 250 and 270 and their descendent nodes are similar to node 230 and its descendent nodes and thus these other child nodes are not described, with one exception. Node 210 (labeled “publicFolder”) has child node 216 (labeled “folders”) that represents a collection of folders associated with the public folder. Node 216 has child nodes 218 (labeled “folder a”) and 222 (labeled “folder n”) that each represent an individual folder associated with the public folder. The labeling of element 222 as “folder n” indicates that the node 216 can have any integer number n of child nodes (and thus that there can be any integer number n of folders within the collection of folders associated with the public folder). The other collections of folders (e.g., those represented by nodes 238, 258 and other nodes not shown) can also have any integer number of folders within their respective collections of folders. It is also to be understood that although the integer number n is used in several elements of FIGS. 2A and 2B, it represents a general integer number that can vary with each element and not a specific number that is the same throughout. Those of skill in the art will understand that the hierarchical structure 200 is not limiting and that it can include other nodes that represent other aspects of the data stored by the facility. Similarly, the facility can organize the data in a hierarchical structure other than the hierarchical structure 200.

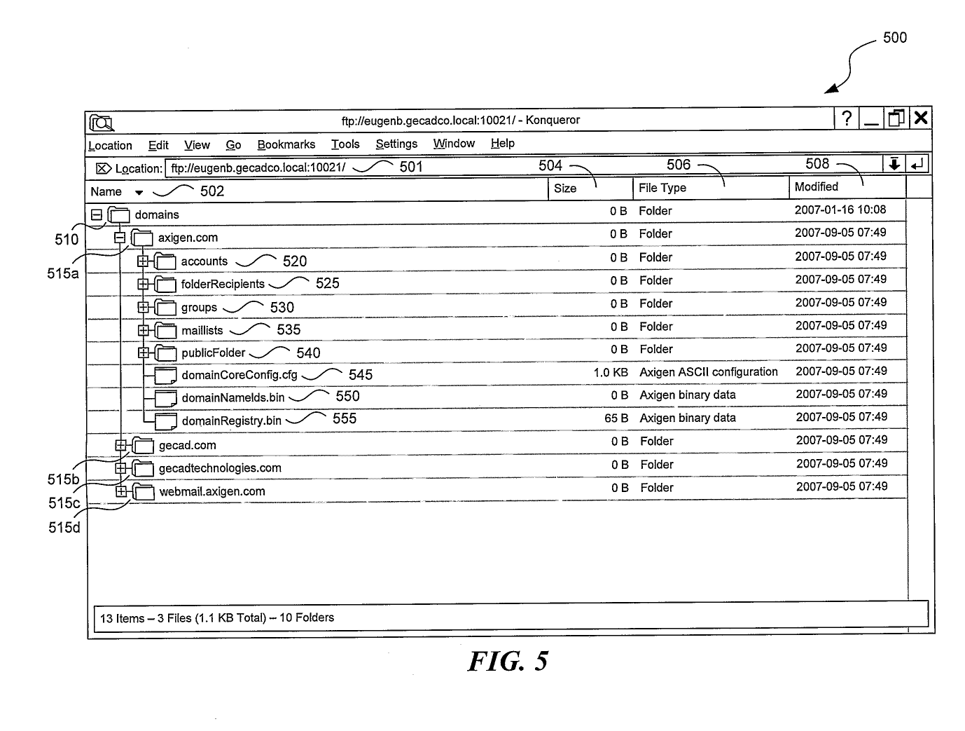

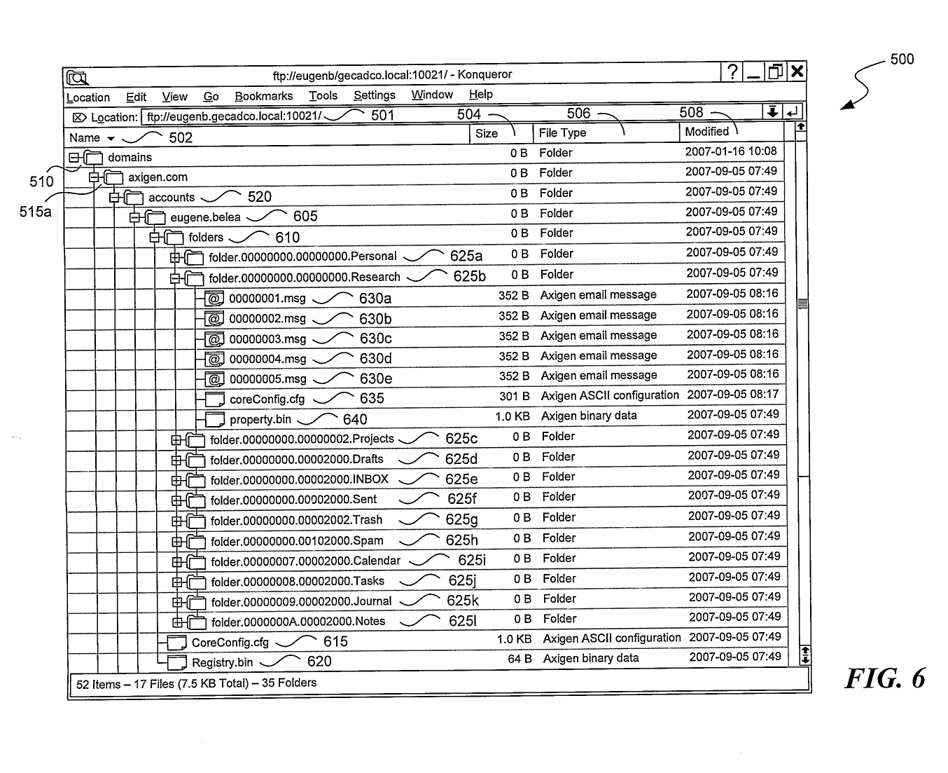

In some embodiments, the FTP backup component 130 described with reference to FIG. 1 creates the hierarchical structure 200. The FTP backup component 130 can do by accessing the data stored in the data storage units, receiving an indication of the stored data and generating the hierarchical structure 200 from the received indication of the stored data. In some embodiments, another component that interfaces between the data storage units and the FTP backup component 130 creates the hierarchical structure 200 and provides it to the FTP backup component 130. The FTP backup component 130 can then map or translate the hierarchical structure 200 into a hierarchical directory/file structure that is understandable to an FTP client that connects to the facility. The administrator utilizing an FTP client sees this translated or mapped hierarchical directory/file structure. In general, there is a one-to-one correspondence between nodes in the hierarchical structure 200 and files and directories in the hierarchical directory/file structure. The top-most or encapsulating directory in the hierarchical directory/file structure corresponds to the root node 202 of the hierarchical structure 200, sub-directories in the hierarchical directory/file structure correspond to nodes below the root node 202 that have child nodes, and files within directories or sub-directories in the hierarchical directory/file structure correspond to leaf nodes. However, leaf nodes in the hierarchical structure 200 can correspond to one or more files in the hierarchical directory/file structure. For example, node 206 (“labeled binary data”) can correspond to one or more files in the hierarchical directory/file structure. The hierarchical directory/file structure viewed by the administrator is discussed in further detail with reference to FIGS. 5 and 6.

### 3. Backing Up Data

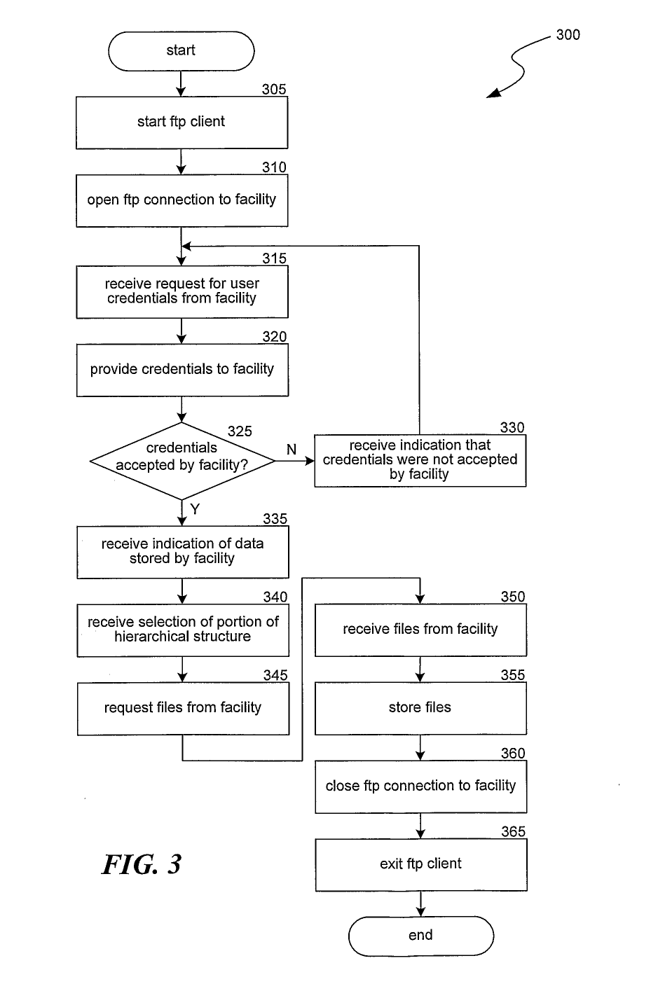

FIG. 3 is a flow diagram of a process 300 for backing up data stored by the facility. The process 300 is described from the perspective of a FTP client utilized by an administrator or user (hereinafter “administrator” in this section) of the facility, but the process 300 could equally well be described from the perspective of the administrator or of the facility. The process 300 begins at block 305 when the FTP client is started by the administrator. FTP clients can include command-line interface FTP programs such as those provided with operating systems (e.g., the program “ftp.exe” on Microsoft® Windows° operating systems or the program “ftp” on Unix-based or Linux-based operating systems) as well as FTP programs that provide a graphical user interface (GUI) (e.g., web browsers such as Microsoft® Internet Explorer or Konqueror). At block 310 the FTP client opens an FTP connection to the facility. At block 315 the FTP client receives a request for user credentials (e.g., user name and password) from the facility. At block 320 the FTP client provides user credentials (e.g., the administrator's credentials) to the facility. At block 325 the facility evaluates the user credentials to determine whether to accept them. If the facility does not accept the user credentials (e.g., if the FTP client provides either an unrecognized user name or an incorrect password), at block 330 the FTP client receives an indication that the facility did not accept the credentials, and the process 300 returns to block 315. If the facility accepts the user credentials, the process 300 continues at block 335 at which the FTP client receives an indication of the data stored by the facility. The indication of data includes the hierarchical directory/file structure corresponding to the hierarchical structure 200. For certain FTP clients, such as command-line interface FTP clients, block 335 may not occur until/unless positively requested by the FTP client, such as by requesting a directory or file listing from the facility. In some embodiments, the facility utilizes the user credentials to determine the hierarchical directory/file structure presented to the FTP client. The facility can do so by checking permissions, such as those stored in the authentication/authorization data storage unit previously described, to determine which portions of the data stored by the facility the user is authorized to access. For example, an administrator may be authorized to access all of the data stored by the facility, in which case the facility may present the entire hierarchical directory/file structure to the administrator's FTP client. As another example, another user may be authorized to access only certain portions of the data stored by the facility. In that case, the facility may present only the portions of the hierarchical directory/file structure that corresponds to the authorized portions of the data to the user's FTP client. In other embodiments, however, the facility presents the entire hierarchical directory/file structure to the FTP client, regardless of the user credentials, and determines whether the user is authorized to access the data when the user requests files in the hierarchical directory/file structure corresponding to the data.

After receiving the hierarchical directory/file structure, the process 300 continues at block 340, in which the FTP client receives a selection of a portion of the hierarchical structure, such as by receiving a selection from the administrator. The selected portion can include objects in the hierarchical directory/file structure such as files and/or directories (hereinafter “files”) that correspond to nodes in the hierarchical structure 200 that represent stored email data. If the FTP client utilizes a command-line interface, the administrator can select files by traversing or navigating the hierarchical structure and issuing the appropriate FTP command to select the files (e.g., the RETR command as specified in RFC 959, which is incorporated by reference herein, or non-standard but widely-implemented FTP commands such as GET and MGET). Alternatively, if the administrator is utilizing an FTP client that implements a GUI the administrator can request files by graphical methods that are well-known in the art (e.g., navigating directories and dragging and dropping). In making a selection of files, the administrator can select files individually or can select directories, which selects files contained within the directories. At block 345 the FTP client requests files from the facility in the selected portion of the hierarchical structure. The requested files are the files that are to be backed-up by the FTP client.

When the facility receives the FTP client's request for files, the FTP backup component 130 retrieves the data from the data storage units that is represented by the nodes in the hierarchical structure 200 corresponding to the requested files. Alternatively, another component (not shown) that interfaces between the data storage units and the FTP backup component 130 can retrieve the corresponding data from the data storage units and provide it to the FTP backup component 130. Although not depicted in FIG. 3, before retrieving data from the data storage units, the facility may perform an intermediate step of determining whether the FTP client is authorized to access the data corresponding to the requested files. The facility may perform this step by checking permissions on an access control list (ACL) or by other well-known methods in the art. If the facility determines that the FTP client is not authorized to access the corresponding data, the facility may indicate that lack of authorization to the FTP client, such as by providing an error message or other message.

At block 350 the FTP client receives the requested files from the facility over the FTP connection. At block 355, the FTP client stores the requested files on the local filesystem as a back-up to the data stored in the data storage units. In this context, the local filesystem refers not only to the filesystem of the computer, system or device that is executing the FTP client utilized by the administrator, but also filesystems of other connected computers, systems or devices. For example, an administrator utilizing one computing system may be utilizing an FTP client being executed on a remote computing system. In this example, the remote computing system's filesystem is the local filesystem upon which the requested files may be stored. As another example, the computing system executing the FTP program may have mounted filesystems and/or partitions associated with remote devices (e.g., tape drives, optical disk drives, hard disk drives, filesystems of other computing systems). In this example, the remote filesystems and/or partitions are the local filesystems upon which the requested files are stored. Those of skill in the art will understand that other configurations are possible and that the term local filesystem does not necessarily or exclusively refer to the filesystem of the computing system directly utilized by the administrator.

At block 360 the FTP client closes the FTP connection to the facility, and at block 365 the administrator exits the FTP client, thereby ending the process 300.

### 4. Restoring Data

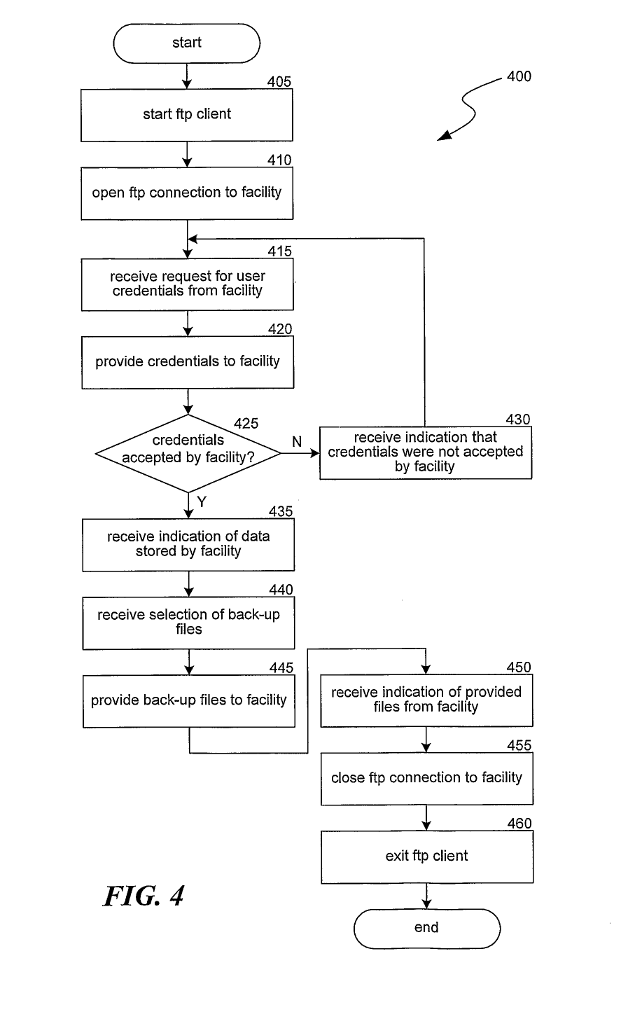

FIG. 4 is a flow diagram of a process 400 for restoring data to a facility configured in accordance with an embodiment of the invention. The process 400 is described from the perspective of a FTP client utilized by an administrator or user or user (hereinafter “administrator” in this section) of the facility, but the process 400 could equally well be described from the perspective of the administrator or of the facility. The process 400 is similar to the process 300 of FIG. 3 in several aspects. The process 400 begins at block 405 when the FTP client is started by the administrator. At block 410 the FTP client opens an FTP connection to the facility. At block 415 the FTP client receives a request for user credentials (e.g., user name and password) from the facility. At block 420 the FTP client provides user credentials (e.g., the administrator's credentials) to the facility. At block 425 the facility evaluates the user credentials to determine whether to accept them. If the facility does not accept the user credentials (e.g., if the FTP client provides either an unrecognized user name or an incorrect password), at block 430 the FTP client receives an indication that the facility did not accept the credentials, and the process 400 returns to block 415. If the facility accepts the user credentials, the process 400 continues at block 435 at which the FTP client receives an indication of the data stored by the facility. The indication of data includes the hierarchical directory/file structure corresponding to the hierarchical structure 200. For certain FTP clients, such as command-line interface FTP clients, block 435 may not occur until/unless positively requested by the FTP client, such as by requesting a directory or file listing from the facility. As previously described with respect to the process 300 for backing up data, in some embodiments, the facility utilizes the user credentials to determine the hierarchical directory/file structure presented to the FTP client. In other embodiments, however, the facility presents the entire hierarchical directory/file structure to the FTP client, regardless of the user credentials, and determines whether the user is authorized to access the data when the user provides back-up files to the facility corresponding to the data.

The FTP client generally has a local hierarchical directory/file structure (or portions thereof) that corresponds to the hierarchical directory/file structure (or portions thereof) received by the FTP client. That is, typically at least some of the local directories and files correspond on a one-to-one basis with at least some of the directories and files in the hierarchical directory/file structure. In other words, the local filesystem mirrors the hierarchical directory/file structure. This is typically true in restore operations in which the FTP client is restoring previously backed-up files. However, the facility is not limited to such cases and the local filesystem does not necessarily have to mirror the hierarchical directory/file structure. After receiving the hierarchical directory/file structure, the process 400 continues at block 440 at which the FTP client receives a selection of local back-up files and/or directories (hereinafter “back-up files”), such as by receiving a selection from the administrator. If the FTP client utilizes a command-line interface, the administrator can select back-up files by traversing or navigating the directory structure of the local filesystem and issuing the appropriate FTP command to select the back-up files (e.g., the STOR command as specified in RFC 959, or non-standard but widely-implemented FTP commands such as PUT and MPUT). Alternatively, if the FTP client implements a GUI the administrator can select back-up files by graphical methods that are well-known in the art (e.g., navigating directories and dragging and dropping). The back-up files selected are the back-up files to be restored to the facility. At block 445 the FTP client provides the selected back-up files (or copies of the selected back-up files) to the facility. When the facility receives the provided back-up files, the FTP backup component 130 maps the provided back-up files to nodes in the hierarchical structure 200 that represent stored data. This mapping allows the FTP backup component 130 to determine which stored data correspond to the provided back-up files. Alternatively, the provided back-up files may not map to existing nodes in the hierarchical structure 200. The FTP backup component then provides the back-up files to the data storage units and receives an indication of the storage from the data storage units. Alternatively, another component that interfaces between the data storage units and the FTP backup component 130 can receive the back-up files from the FTP backup component 130, provide the back-up files to the data storage units, receive an indication of the storage from the data storage units and provide the indication to the FTP backup component 130. The received back-up files may replace existing stored data, may replace missing data or the back-up files may not correspond to any of the stored data (currently or previously existing). In this last case, the back-up files are new data. In some embodiments, if the received back-up files correspond to existing data, the facility merges the received back-up files with the corresponding existing data instead of overwriting the corresponding existing data. The facility can automatically determine whether to merge instead of overwrite based upon various factors or the facility can provide the merge capability as an option to the administrator. Although not depicted in FIG. 3, before the facility stores the received back-up files the facility may perform an intermediate step of determining whether the FTP client is authorized to access the stored data corresponding to the provided back-up files (in the case in which the corresponding stored data already exists and thus will be overwritten) or the stored data in which data corresponding to the provided back-up files will be created (in the case of new back-up files provided by the administrator). The facility may perform this step by checking permissions on an access control list (ACL) or by other well-known methods in the art. If the facility determines that the FTP client is not authorized to access the appropriate stored data, the facility may indicate that lack of authorization to the FTP client, such as by providing an error message or other message.

At block 450 the FTP client receives an indication of the storage of the provided back-up files from the facility, such as a confirmation message, status update or log message. At block 455 the FTP client closes the FTP connection to the facility, and at block 460 the administrator exits the FTP client, thereby ending the process 400.

### 5. FTP Client Interfaces

FIG. 5 is a representative screenshot depicting an interface 500 of an FTP client that is accessing the facility. As depicted, the FTP client interface 500 implements a GUI for facilitating file transfers (e.g., backup and restore operations). The interface 500 includes a location region 501 which displays the hostname (eugenb.gecadco.local) of the facility as well as the port (10021) on which the FTP server listens for incoming connections and accepts connections. The interface 500 also includes various columns for displaying information about the files and directories (folders) in the hierarchical directory/file structure presented by the facility to the FTP client. These columns include a name column 502, which displays the name of the files and folders. A size column 504 displays the size (in bytes, kilobytes, megabytes or other measurements) of the files and folders. A file type column 506 displays information about the files (e.g., the type of file) and folders, and a modified column 408 displays the last modified timestamp of the files and folders.

In some embodiments, the first element in the hierarchical directory/file structure presented by the facility to the FTP client is a “domains” folder 510. The “domains” folder 510 corresponds to the root node 202 of the hierarchical structure 200 illustrated in FIGS. 2A and 2B. As previously noted, the facility can provide email services for numerous domains, some of which may be related to each other or which each may be unrelated discrete logical entities. As depicted, the FTP client interface 500 displays four domains (shown individually as domains 515a-d) that the facility provides email services for. Each domain 515 can have folders directly beneath it. The “axigen.com” domain 515a includes the following folders: “accounts” folder 520, “folderRecipients” folder 525, “groups” folder 530, “maillists” folder 535 and “publicFolder” folder 540.

Each domain 515 can also include files. The “axigen.com” domain 515a includes the following files: “domainCoreConfig.cfg” file 545, “domainNameIds.bin” file 550 and “domainRegistry.bin” file 555. The “domainCoreConfig.cfg” file 545 is an ASCII text file that is human-readable with a standard ASCII text editor and can be modified with such an editor. The “domainCoreConfig.cfg” file 545 can include configuration data that can be viewed and edited by administrators that can affect the functioning of the facility. An administrator can download the “domainCoreConfig.cfg” file 545 (e.g., using the back-up process described with reference to FIG. 3) and edit it on the administrator's local filesystem. The administrator can then upload the “domainCoreConfig.cfg” file 545 (e.g., using the restore process described with reference to FIG. 4) to the facility's data storage units. Restoring the “domainCoreConfig.cfg” file 545, because it overwrites the existing corresponding stored data, can have the effect of triggering a restart or reconfiguration of the facility. This allows the changes made by the administrator to be incorporated by the facility, thus affecting the functioning of the facility. Therefore, one advantage provided by the facility is the ability to quickly and easily restart or reconfigure the facility by modifying configuration files with standard ASCII text editors and restoring such files.

The “domainNameIds.bin” file 550 and “domainRegistry.bin” file 555 can be binary files that contain internal usage data created and modified by the facility to affect its functioning. Typically such data is contained within binary files to prevent facile editing of the binary files as described in the previous paragraph. However, in some embodiments such data can be contained within ASCII text files that can be edited using standard ASCII text editors. In these embodiments, administrators can edit the files to modify the internal usage data, and the restoration of modified files can trigger system restarts or reconfigurations to capture such modifications. Alternatively or additionally, in a restore operation, the facility can merge the data in the restored files with the data stored by the facility in the data storage units. In some instances, this merging of two sets of data (the restore data and the existing data) is preferable to allowing the restore data to overwrite the existing data.

FIG. 6 is another representative screen shot depicting the FTP client interface 500 of FIG. 5. In FIG. 6, the “accounts” folder 520 has been expanded to display portions of the hierarchical structure beneath it. The “accounts” folder 520 contains a “eugene.belea” folder 605 that corresponds to a user with the username of “eugene.belea” in the domain “axigen.com” 515a. The “eugene.belea” folder 605 contains numerous folders (shown individually as folders 625a-l). The folders 625 can correspond to folders within the email data store associated with the user having the username “eugene.belea.” The “folder.000000.00000000.Research” folder 625b is shown as expanded by the FTP client 500 to display the files within it. The files 630 (shown individually as files 630a-e) can correspond to email messages stored in the data storage units of the facility. The “coreConfig.cfg” file 635 (as well as the “coreConfig.cfg” file 615) is an ASCII text file that is human-readable with a standard ASCII text editor and can be modified with such an editor as previously described. The “property.bin” file 640 (as well as the “registry.bin” file 620) is a binary file that is not editable with a standard ASCII text editor but can contain internal usage data that can affect the functioning or attributes of the folder that contains it.

The FTP client interface 500 depicted in FIGS. 5 and 6 presents data from the facility in a logically organized, hierarchical directory/file structure. One advantage of this logical, hierarchical directory/file structure is that it provides excellent granularity for back-up and restore operations of data stored by the facility. Specifically, the facility allows administrators to use a standard FTP client to select the specific files, such as individual email messages, corresponding to the stored data the administrator wishes to back up. Similarly, an administrator can use a standard FTP client to select back-up files on the local filesystem to restore to corresponding stored data on the facility. This differs from prior art email systems, which typically store email messages in one or more files which can be backed up or restored over an FTP connection, but which cannot allow back-up or restoration of individual email messages or individual portions of the files over an FTP connection. Another advantage of the facility's implementation of an FTP service to facilitate back-up and restore operations is that it is easily integrated with numerous backup systems. For example, any back-up system that can mount an FTP filesystem or can communicate with an FTP server through the well-understood FTP protocol can be used for back-up and restore operations. Another advantage of the facility is that administrators can automate common back-up operations using FTP scripts written in scripting languages that are well-known in the art. For example, an administrator could script a back-up operation that performs a full back-up of all data stored by the facility on a periodic basis (e.g., weekly, monthly). The administrator could then script incremental back-ups on a more frequent basis (e.g., nightly). Another back-up operation could be scripted to perform back-ups of each or some of the domains hosted by the facility. As a third example, an administrator could script a back-up operation that performs back-ups of individual accounts. Administrators can then instruct the facility to perform these scripts on a periodic or ad-hoc basis as necessary.

### 6. Conclusion

The foregoing description details certain embodiments of the invention. It will be appreciated, however, that no matter how detailed the foregoing appears in text, the invention can be practiced in many ways. For example the facility can be implemented as a distributed computing system, with components of the facility being implemented and/or executed on disparate systems that are connected over a network. The facility could equally well be executed as a standalone system. Moreover, the facility may utilize third-party services and data to implement all or portions of its functionality. Although the subject matter has been described in language specific to structural features and/or methodological steps, it is to be understood that the subject matter defined in the claims is not necessarily limited to the specific features or steps described. Rather, the specific features and steps are disclosed as preferred forms of implementing the claimed subject matter.

The above Detailed Description of embodiments of the invention is not intended to be exhaustive or to limit the invention to the precise forms disclosed. While various embodiments are described in terms of the environment described above, those skilled in the art will appreciate that various changes to the facility may be made without departing from the scope of the invention. For example, those skilled in the art will appreciate that the actual implementation of the data store 135 may take a variety of forms. The term “data store” is used herein in the generic sense to refer to any data structure that allows data to be stored and accessed, such as databases, tables, linked lists, arrays, etc. As another example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

These and other changes can be made to the invention in light of the above Detailed Description. Accordingly, the actual scope of the invention encompasses not only the disclosed embodiments, but also all equivalent ways of practicing or implementing the invention under the final claims.

I/we claim:

1. An email system, comprising:
an input component configured to receive emails;
a storage component configured to store the received emails non-hierarchically; and
an ftp component configured to:
accept a connection from an ftp client; and
provide to the ftp client a hierarchical structure that enables access to the stored emails on an individual email basis.

2. The email system of claim 1 wherein the ftp component is further configured to generate the hierarchical structure.

3. The email system of claim 1, further comprising an interface component configured to generate the hierarchical structure.

4. The system of claim 1 wherein the ftp component is further configured to receive requests for stored emails from the ftp client and provide the requested stored emails to the ftp client.

5. The system of claim 1 wherein the ftp component is further configured to receive user credentials from the ftp client and the hierarchical structure is generated based upon the received user credentials.

6. The system of claim 1 wherein the hierarchical structure includes at least one directory.

7. The system of claim 6 wherein the storage component is further configured to store data associated with at least one domain and the at least one directory corresponds to the at least one domain.

8. The system of claim 6 wherein the storage component is further configured to store data associated with at least one account and the at least one directory corresponds to the at least one account.

9. The system of claim 1 wherein the hierarchical structure includes at least one file that corresponds to an individual one of the stored emails.

10. The system of claim 1 wherein the storage component is further configured to store configuration data and the hierarchical structure enables access to the configuration data.

11. A method of backing up email data, the method comprising:
opening an ftp connection to an email system, wherein the email system stores email data including a plurality of emails stored non-hierarchically;
receiving from the email system an indication of a hierarchical structure that has at least one object that represents a stored email;
receiving a selection of a portion of the hierarchical structure, the selected portion having one or more objects;
providing to the email system an indication of the selected portion;
receiving from the email system the email data corresponding to the one or more objects in the selected portion; and
storing the received email data as a back-up to the stored email data of the email system.

12. The method of claim 11 wherein at least one of the one or more objects in the selected portion represents a stored email.

13. The method of claim 11 wherein the stored email data further includes email data associated with at least one domain and one of the objects in the selected portion represents the at least one domain.

14. The method of claim 13 wherein the object that represents the at least one domain has child objects and receiving the email data corresponding to the object that represents the at least one domain includes receiving the email data corresponding to the child objects.

15. The method of claim 11 wherein the stored email data further includes email data associated with at least one account and one of the objects in the selected portion represents the at least one account.

16. The method of claim 15 wherein the object that represents the at least one account has child objects and receiving the email data corresponding to the object that represents the at least one account includes receiving the email data corresponding to the child objects.

17. The method of claim 11 wherein the stored email data further includes email configuration data and one of the one or more objects in the selected portion represents the email configuration data.

18. A method of restoring email data, the method comprising:
opening an ftp connection from a client that has a plurality of back-up files to an email system that stores email data that includes a plurality of emails stored non-hierarchically;
receiving from the email system an indication of a hierarchical structure, wherein the hierarchical structure has a plurality of objects that map on a one-to-one basis to the plurality of stored emails;
receiving a selection of at least one back-up file from among the plurality of back-up files to restore to the stored email data; and
providing to the email system the at least one back-up file.

19. The method of claim 18, wherein the at least one back-up file includes an email.

20. The method of claim 19 wherein the at least one back-up file corresponds to an object that is mapped to a stored email.

21. The method of claim 18 wherein the at least one back-up file does not correspond to any object in the hierarchical structure.

22. The method of claim 18, wherein the stored email data further includes email configuration data, the hierarchical structure further has an object that maps to the email configuration data, the at least one back-up file includes a configuration file and the at least one back-up file corresponds to the object in the hierarchical structure that is mapped to the email configuration data.

23. The method of claim 22, wherein the at least one back-up file overwrites the email configuration data, thereby triggering a reconfiguration of the email system.

24. The method of claim 18, wherein the stored email data further includes email data associated with at least one domain, the hierarchical structure further has an object that maps to the at least one domain, the client further has at least one back-up folder, and further comprising:
receiving a selection of the at least one back-up folder; and
providing to the email system the at least one back-up folder, wherein the at least one back-up folder corresponds to the object that is mapped to the domain.

25. The method of claim 18, wherein the stored email data further includes email data associated with at least one account, the hierarchical structure further has an object that maps to the at least one account, the client further has at least one back-up folder, and further comprising:
receiving a selection of the at least one back-up folder; and
providing to the email system the at least one back-up folder, wherein the at least one back-up folder corresponds to the object that is mapped to the account.
